(19) United States
(12) Patent Application Publication
(10) Pub. No.: US 2017/0255080 A1
(43) Pub. Date: Sep. 7, 2017

(54) Multi-Bit Digital-Electrical to Analog-Optical Conversion Based on Non-Linear Optical Element

(71) Applicant: Irfan Muhammad Fazal, Ottawa (CA)

(72) Inventor: Irfan Muhammad Fazal, Ottawa (CA)

(21) Appl. No.: 15/057,827

(22) Filed: Mar. 1, 2016

(51) Int. Cl. G02F 7/00; H04B 10/2575; H04J 14/02

(52) U.S. Cl. CPC G02F 7/00; H04J 14/02; H04B 10/2575

(57) ABSTRACT

A digital-electrical to analog-optical converter for converting a N-bit digital data signal uses a periodically poled non-linear waveguide connected to (i) N optical signals each modulated by a corresponding bit stream of the N-bit digital data signal, (ii) N pump optical signals and (iii) a probe optical signal to generate an output optical signal having an amplitude corresponding to the N-bit digital data signal. The output optical signal is filtered out from other optical signals output from the periodically poled non-linear waveguide by an optical filter.

### TECHNICAL FIELD

The current disclosure relates to optical networks and in particular to a multi-bit digital-electrical to analog-optical converter.

### BACKGROUND

5^{th} generation, or 5G, cellular service will require several GHz of bandwidth to be supplied to individual cellular antennas. Radio over fiber (RoF) technology has the ability to scale to such high bandwidth requirements due to the THz of bandwidth provided by fiber optic cables. The fiber channel can also provide wavelength division multiplexing to accommodate a high number of wireless channels. Transmitting analog signals directly to a cellular antenna for transmission into free-space instead of transmitting digital data to the antenna and then converting the digital data to analog at the top of the antenna has an advantage of removing complexity from the remote antenna. In such RoF transmission systems, the digital to analog conversion may be done at a central office or at a remote distribution unit and an optical detector at the transmitter's antenna converts the transmitted radio frequency (RF) optical signal to an RF electrical signal for use in driving the antenna.

Several techniques have been proposed for the digital to analog conversion for use in RoF transmission systems. Some silicon photonics based modulators use the RF digital electrical signals to directly control multiple phase shifters located in an arm of a Mach-Zehnder interferometer (MZI) structure, which results in modulating an amplitude of the output optical signal. However, incorporating the electrically controlled phase shifters into a single MZI structure requires the individual phase shifters to be disposed in a close physical proximity to each other, which can result in crosstalk between the RF electrical signals applied to individual phase shifters. Other modulators may reduce the RF crosstalk by using separate optical wavelengths for each digital bit stream, which allows the RF electrical bit signals to be physically separated; however, such modulation results in spectral inefficiency since each individual bit stream is modulated by a separate wavelength and as such a multi-bit signal will be modulated by multiple different wavelengths. Further, walk-off between different wavelengths over a long length of fiber would require compensation, increasing the system complexity.

An additional, alternative and/or improved digital to analog modulator for use in converting a multi-bit digital electrical signal to a corresponding analog optical signal is desired.

### SUMMARY

In accordance with the present disclosure there is provided a digital to analog converter (DAC) for converting an N-bit digital electrical signal into a corresponding analog optical signal, the DAC comprising: N digitally modulated optical bit stream sources, wherein each modulated optical bit stream source is configured for providing an optical signal at a distinct optical frequency fₙ, wherein the optical signal at the distinct optical frequency fₙ is modulated according to a respective bit bₙ of the N-bit digital-electrical signal; a non-linear optical element optically coupled to the N digitally modulated optical bit stream sources and configured for outputting a frequency-shifted optical signal when coupled to N complementary optical signals each of the N complementary optical signals having an optical frequency of fₙ*, wherein fₙ+fₙ*=2f_{qpm} for n=1 . . . N, where f_{qpm} is a quasi-phase matching (QPM) frequency of the non-linear optical element, and wherein the frequency-shifted optical signal has an optical frequency of 2f_{qpm}; and an optical filter optically coupled to an output of the non-linear optical element and configured for outputting the analog optical signal at an optical frequency f_{filter} while suppressing the optical signals at the optical frequencies fₙ and fₙ*, wherein the analog optical signal is based on the frequency-shifted optical signal.

In an embodiment of the DAC, the non-linear optical element comprises a periodically poled non-linear waveguide configured for generating the frequency-shifted optical signal based on a sum frequency generation (SFG) process within the periodically poled non-linear waveguide.

In a further embodiment, the DAC further comprises a probe signal source optically coupled to the periodically poled non-linear waveguide for providing a probe optical signal having an optical frequency of f_{probe}, wherein f_{filter}=2f_{qpm}−f_{probe} wherein the periodically poled non-linear waveguide is configured for generation of a second frequency-shifter optical signal based on difference frequency generation (DFG) process between the frequency-shifted optical signal and the probe optical signal in the periodically poled non-linear waveguide.

In a further embodiment of the DAC, b₁ is a most significant bit and b_{N} is a least significant bit of the N-bit electrical-digital signal, and wherein each of the N digitally modulated optical bit stream sources is associated with modulating a respective optical signal having an amplitude of

$${A}_{n} = \frac{{A}_{0}}{{2}^{n - 1}} ,$$

where A₀ is an amplitude representing the most significant bit.

In a further embodiment of the DAC, one or more of the N digitally modulated optical bit stream sources comprise: a laser outputting an optical signal at the respective frequency fₙ at an amplitude greater than Aₙ; an attenuator for attenuating the amplitude of the optical signal to Aₙ; and a modulator for modulating the optical signal according to the respective bit bₙ of the digital electrical signal.

In a further embodiment of the DAC, the attenuator is coupled between the laser and the modulator.

In a further embodiment of the DAC, one or more of the N digitally modulated optical bit stream sources comprise: a laser outputting an optical signal at the respective frequency fₙ at an amplitude of Aₙ; and a modulator for modulating the optical signal according to the respective bit bₙ of the digital electrical signal.

In a further embodiment of the DAC, the periodically poled non-linear waveguide comprises a periodically poled lithium niobate (PPLN) waveguide.

In a further embodiment of the DAC, one or more of the N digitally modulated optical bit stream sources comprise: a directly modulated laser diode outputting an optical signal at the respective frequency fₙ at an amplitude of Aₙ that is modulated according to the respective bit bₙ of the digital electrical signal.

In a further embodiment, the DAC further comprises N continuous wave laser diodes optically coupled to the non-linear optical element for providing the N complementary optical signals.

In a further embodiment, the DAC further comprises one or more multi-wavelength optical sources optically coupled to the non-linear optical element for providing the N complementary optical signals.

In accordance with the present disclosure there is further provided a radio over fiber (RoF) system for transmitting a plurality of analog radio-frequency signals to a plurality of transmission locations, the RoF system comprising: a plurality of digital to analog converters (DACs), each of the plurality of DACs for converting an N-bit digital electrical signal into a corresponding analog optical signal and comprising: N digitally modulated optical bit stream sources, wherein each modulated optical bit stream source is configured for providing an optical signal at a distinct optical frequency fₙ, wherein the optical signal at the distinct optical frequency fₙ is modulated according to a respective bit bₙ of the N-bit digital-electrical signal; a non-linear optical element optically coupled to the N digitally modulated optical bit stream sources and configured for outputting a frequency-shifted optical signal when coupled to N complementary optical signals each of the N complementary optical signals having an optical frequency of fₙ*, wherein fₙ+fₙ*=2f_{qpm} for n=1 . . . N, where f_{qpm} is a quasi-phase matching (QPM) frequency of the non-linear optical element, and wherein the frequency-shifted optical signal has an optical frequency of 2f_{qpm}; and an optical filter optically coupled to an output of the non-linear optical element and configured for outputting the analog optical signal at an optical frequency f_{filter} while suppressing the optical signals at the optical frequencies fₙ and fₙ*, wherein the analog optical signal is based on the frequency-shifted optical signal; a wavelength multiplexer for multiplexing the plurality of analog optical signals output from the optical filters of the plurality of DACs into a single optical fiber output; a wavelength demultiplexer for demultiplexing the plurality of optical signals; and an optical fiber coupling the wavelength multiplexer to the wavelength demultiplexer.

In a further embodiment, the RoF system further comprises: a plurality of transmitters each located at a respective one of the plurality of transmission locations and coupled to a respective one of the plurality of optical signals output from the wavelength demultiplexer, each of the transmitters comprising: a photo detector for converting the respective optical signal to a corresponding radio frequency (RF) electrical signal; an electrical amplifier for amplifying the RF electrical signal to an RF driving signal; and an antenna for radiating the RF driving signal in free space.

In a further embodiment of the RoF system, each of a plurality of optical fibers coupling the optical signals output from the wavelength demultiplexer to the respective transmitters have a respective length of less than 800 m.

In a further embodiment of the RoF system, the optical fiber coupling the wavelength multiplexer to the wavelength demultiplexer is between 0 km and 20 km in length.

In a further embodiment of the RoF system, the non-linear optical element of one or more of the plurality of DACs comprises a periodically poled lithium niobate (PPLN) waveguide.

In accordance with the present disclosure there is further provided a method of converting an N-bit digital-electrical signal to a corresponding analog-optical signal, the method comprising: digitally modulating N optical signals according to N bit streams of the N-bit digital-electrical signal; combining the N digitally modulated signals with N pump optical signals in a non-linear optical element; and filtering an output of the non-linear optical element to provide an output analog optical signal having an amplitude corresponding to the N-bit digital-electrical signal.

In a further embodiment of the method, the N digitally modulated optical signals each have a respective frequency of fₙ, where n corresponds to a significance of the bit, bₙ, modulating the optical signal, with bit b₁ being a most significant bit and b_{N} being a least significant bit of the N-bit electrical-digital signal and the N pump signals each have an associated frequency of fₙ*, where 2f_{qpm}=fₙ+fₙ* for n=1 . . . N and f_{qpm} is a quasi-phase matching (QPM) frequency of the non-linear optical element.

In a further embodiment of the method, the non-linear optical element comprises a periodically poled non-linear waveguide, the method further comprising combining a probe signal having an optical frequency of f_{probe} with the N digitally modulated signals and the N pump optical signals in the periodically poled non-linear waveguide, wherein the output of the periodically poled non-linear waveguide is filtered to output an optical signal at a wavelength of f_{filter}=2f_{qpm}−f_{probe}

In a further embodiment, the method further comprises: attenuating each of the N optical signal to an amplitude of

$${A}_{n} = \frac{{A}_{0}}{{2}^{n - 1}} ,$$

where A₀ is an amplitude representing the most significant bit.

### BRIEF DESCRIPTION OF THE DRAWINGS

Embodiments are described herein with reference to the appended drawings, in which:

FIG. 1 depicts a periodically poled non-linear waveguide;

FIG. 2A depicts a sum frequency generation (SFG) process that may occur within a periodically poled non-linear waveguide;

FIG. 2B depicts a difference frequency generation (DFG) process that may occur within a periodically poled non-linear waveguide;

FIG. 3 depicts a N-bit digital-electrical to analog-optical converter that uses a periodically poled non-linear waveguide;

FIG. 4 depicts digitally modulated bit stream source embodiments in accordance with the present disclosure;

FIG. 5 depicts the conversion of a multi-bit digital electrical signal to an analog optical signal;

FIG. 6 depicts conversion of an 8 bit data signal to an amplitude modulated optical signal within a periodically poled non-linear waveguide;

FIG. 7 depicts a further conversion of an 8 bit data signal to an amplitude modulated optical signal within a periodically poled non-linear waveguide;

FIG. 8 depicts the digital electrical to analog optical conversion process when one or more of the bit streams have a value of ‘0’; and

FIG. 9 depicts a radio over fiber (RoF) transmission system incorporating a digital-electrical to analog-optical converter.

### DETAILED DESCRIPTION

A digital-electrical to analog-optical converter is described herein that provides an analog optical signal that corresponds to a digital electrical signal. The converter is described with particular reference to its use in a radio-over-fiber (RoF) application; however, it may be used in other applications in which it is desirable to carry an analog version of a digital signal over a fiber optic cable. The converter described herein provides low RF crosstalk by allowing physical separation between RF electrical signals. The converter does not rely on electrically controlled phase shifters located in an arm of a Mach-Zehnder interferometer (MZI) modulator and as such, it is possible to provide sufficient physical separation between the electrical signals to reduce the RF crosstalk to acceptable or desired levels. Further, the converter described herein may provide high spectral efficiency since each multi-bit RF electrical signal can be modulated on a single wavelength, allowing multiple modulated multi-bit RF signals to be multiplexed onto a single fiber optic cable. Further, the converter structure may be implemented in a simple structure using a relatively low number of optical elements. As described in further detail, the converter may provide a high resolution of at least 8-10 bits while maintaining a high signal to noise ratio. The converter can provide high spectral efficiency for wavelength division multiplexing (WDM) applications.

As described further below, the digital-electrical to optical-analog conversion may be based on a periodically poled non-linear waveguide or another non-linear optical element, such as non-linear birefringent crystal, for example. The periodically poled non-linear waveguide is described with particular reference to a periodically poled lithium niobate (PPLN) waveguide; however other types of periodically poled non-linear waveguides may be used. In a PPLN waveguide, the orientation of the lithium niobate crystal is periodically inverted, or poled. The micro-structure of the PPLN waveguide give rise to non-linear effects, including a sum frequency generation (SFG) process and a difference frequency generation (DFG) process. The PPLN waveguide is coupled to a number of optical signals, including digitally modulated signals corresponding to the bit streams of data to be converted. The signals may be combined together within the PPLN waveguide to generate an output signal whose output is proportional to the combined amplitudes of the bit stream-modulated optical signals. Accordingly, a multi-bit digital-electrical signal can be used to modulate a number of optical signals, which can be combined together within a periodically poled non-linear waveguide to provide a single output with an amplitude corresponding to the digital-electrical data.

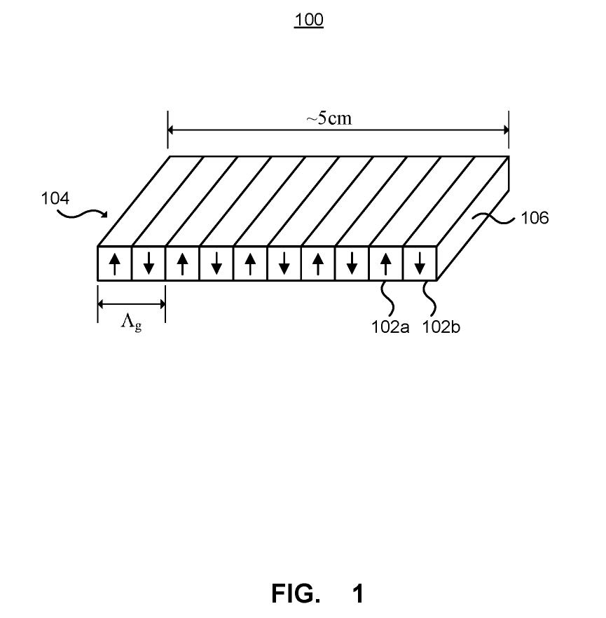

FIG. 1 depicts a periodically poled non-linear waveguide, which is described as a PPLN waveguide 100. The micro-structure of the PPLN waveguide 100 comprises a number of inverted sections 102a, 102b arranged together. The PPLN waveguide 100 may have an input face 104 at which optical signals can be received and an output face 106 at which the optical signals are output. The specific characteristics of the PPLN waveguide 100 can be adjusted for different particular applications. However, as an example, for wavelengths in the C-Band range, the periodicity of the poling of the PPLN waveguide 100 may be Λ_{g}=˜16 μm and the total length of the PPLN waveguide 100 may be for example ˜5 cm. The structure of the PPLN waveguide 100 can be designed to provide quasi phase matching (QPM) at a particular optical frequency f_{qpm} and wavelength λ_{qpm}. Although the PPLN waveguide 100 is configured to provide a particular quasi-phase matched (QPM) optical frequency, the optical frequency may be tuned over a limited range by adjusting temperature of the PPLN waveguide.

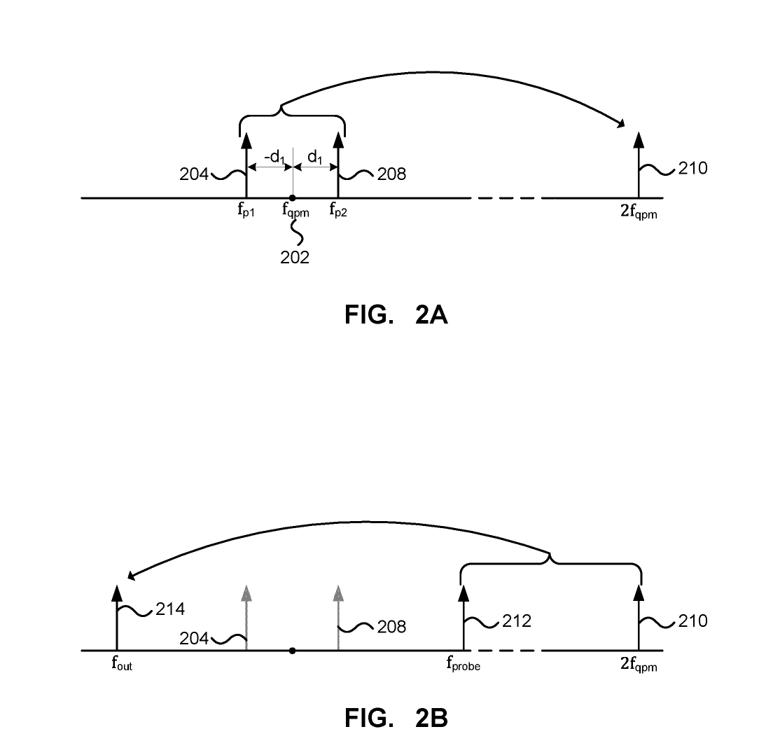

FIG. 2A depicts a sum frequency generation (SFG) process that may occur within a periodically poled non-linear waveguide, such as the PPLN waveguide 100 described above with reference to FIG. 1. FIG. 2A depicts optical signals as arrows along an axis representing optical frequencies. Two optical signals 204, 208, are supplied to the input face of the PPLN waveguide. The two signals 204, 208, each have an optical frequency of fₚ₁ and fₚ₂ respectively. The micro-structure of the PPLN waveguide 100 results in a particular QPM frequency (f_{qpm}) 202. The optical frequencies of the two optical signals 204, 208 are equally spaced away from, and on opposite sides of, f_{qpm}. Accordingly, the optical frequencies of the two signals fₚ₁ and fₚ₂ are such that (fₚ₁−f_{qpm})=−(fₚ₂−f_{qpm}). The non-linear waveguide, by virtue of the SFG process, generates a frequency-shifted optical signal, depicted as arrow 210, at an optical frequency that is the sum of the two input optical signals 204, 208. Since the optical frequencies of the two input optical signals 204, 208 are arranged symmetrically about f_{qpm}, this results in the SFG process generating an optical signal at an optical frequency of 2f_{qpm}. The amplitude of the generated signal 210 is proportional to the product of the amplitudes of the two input signals 204, 208.

FIG. 2B depicts a difference frequency generation (DFG) process that may occur within a PPLN waveguide, such as the PPLN waveguide 100 described above with reference to FIG. 1. The two input optical signals 204, 208 described above are shown in grey in FIG. 2B as they are not directly involved in the DFG process, although they do produce the generated signal 210 that is involved in the DFG process. The DFG process produces another frequency-shifted optical signal depicted as arrow 214 that has an optical frequency of fₒᵤₜ. A probe optical signal, depicted as vector 212 is supplied to the input face of the PPLN waveguide. The probe signal 212 has an optical frequency of f_{probe}. The PPLN waveguide, and in particular the DFG process, generates the optical signal 214 at an optical frequency that is equal to the difference of the optical frequencies of the two signals 210, 212. That is fₒᵤₜ=2f_{qpm}−f_{probe}. As with the SFG process, the generated optical signal at fₒᵤₜ has an amplitude that is proportional to the product of the amplitudes of the two difference signals 210, 212.

As described in further detail below, the SFG and DFG processes of a non-linear waveguide can be combined in order to provide multi-bit optical converter that can convert a multi-bit digitally modulated signal into a corresponding amplitude modulated optical signal. The SFG process combines a number of modulated optical signals together into a single optical signal. Although the generated signal from the SFG process may provide an appropriate signal, that is an optical signal corresponding to the digital-electrical signal, the optical frequency may be too high, or the wavelength may be too short, for propagation in a typical single mode optical fiber. Accordingly, the DFG process allows the SFG generated signal to be output at a lower optical frequency with a corresponding longer wavelength. The particular optical frequency of the DFG generated output signal may be adjusted by changing the optical frequency of the probe signal 212.

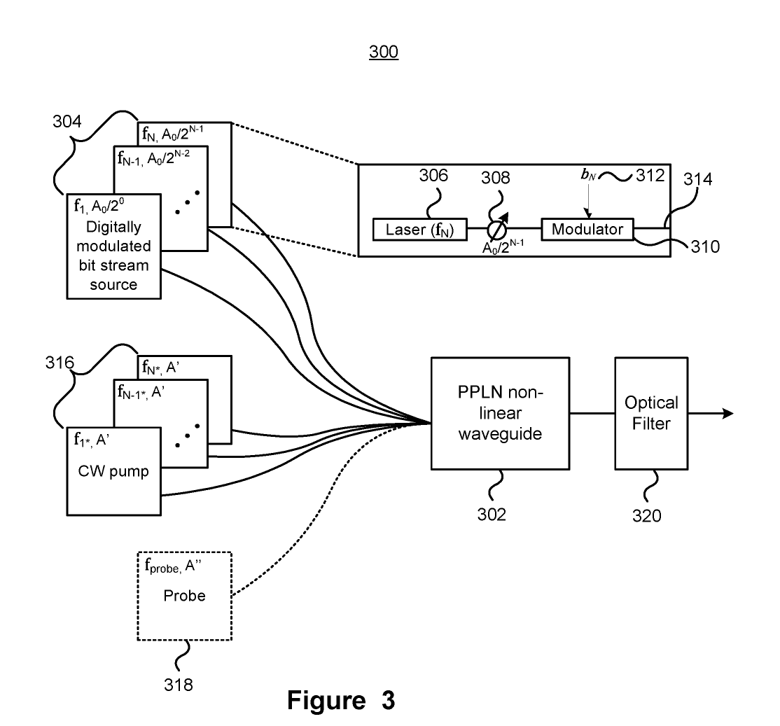

FIG. 3 depicts a N-bit digital-electrical to analog-optical converter 300 that uses a PPLN non-linear waveguide 302 for combining N digitally modulated optical signals 304 to produce a single optical output whose amplitude corresponds to the N-bit digital-electrical data. The N-bit electrical data may be defined as

$$B = {\sum }_{i = 1 ¨ N} \frac{{b}_{i}}{{2}^{i - 1}} ,$$

where bᵢ is a bit stream, with b₁ being the most significant bit stream and b_{N} being the least significant bit stream. Each bit stream bᵢ is used to modulate an associated optical carrier that has an associated optical frequency fᵢ and amplitude

$${A}_{i} = \frac{{A}_{0}}{{2}^{i - 1}} ,$$

for i=1 . . . N, where A₀ is the largest amplitude. The i^{th} digitally modulated signal modulates the optical carrier at optical frequency fᵢ and amplitude Aᵢ according to the bit stream bᵢ of the N-bit electrical data B. That is, when the bit stream bᵢ has a value of ‘1’, the optical carrier at optical frequency fᵢ will be modulated to have an amplitude of Aᵢ. when the bit stream bᵢ has a value of ‘0’, the optical carrier at optical frequency f₁ will be modulated to have an amplitude of ‘0’. It will be appreciated that the modulated amplitudes of Aᵢ and 0 are ideal values and in practice the exact may not be attained by the modulators.

The individual digitally modulated optical bit stream sources 304 may be provided in various ways. As depicted, an optical source 306, such as a laser producing a continuous wave optical signal, provides an optical signal at the appropriate optical frequency, which as depicted in FIG. 3 is f_{N}. The optical source 306 is attenuated by an attenuator 308 to have an amplitude of A₀/2^{N-1}. The desired amplitude may be obtained in other ways than the attenuator 308. For example, the power output of the laser 306 may be controlled in order to output the appropriate amplitude for the particular optical source. The optical signal provided by the optical source 306 is modulated by a modulator 310 that is controlled by the associated digital-electrical bit stream 312, which as depicted in FIG. 3, is bit stream b_{N}. The modulator 310 may be provided by various components. One example of a modulator is a Mach-Zehnder type modulator. Other types of modulators are possible. The ideal operation of the modulator outputs the optical carrier having an amplitude of

$$\frac{{A}_{0}}{{2}^{N - 1}}$$

when b_{N}=1 and completely blocking the optical carrier when b_{N}=0. It will be appreciated that actual realizations of the modulator will not behave in such an ideal manner, and the amplitudes of the modulated carrier corresponding to “1” and “0” may depart from the ideal values. Output 314 of the modulator 310 is a digitally modulated optical bit stream corresponding to the electrical bit stream used to modulate the optical carrier with an amplitude corresponding to the significance of the bit stream. Although FIG. 3 depicts the attenuator 308 located between the optical source 306 and the modulator 310, it is possible for the attenuator to be located after the modulator 310. The individual modulators 310 used to modulate different bit streams of the data may by separated from each other physically by a sufficient distance to prevent, or at least reduce, crosstalk between the electrical signals of the bit streams.

In addition to the N digitally modulated optical bit streams 304, the PPLN non-linear waveguide is also connected to N continuous wave (CW) pump signals 316. Each of the N CW pumps may be provided by a laser having an optical frequency that is complementary to one of the optical frequencies of the modulated optical bit streams. The complementary frequencies may be denoted fᵢ*, where 2f_{qpm}=fᵢ+fᵢ*, for i=1 . . . N. Each of the CW pumps 316 may have the same amplitude, depicted as A′ in FIG. 3. The PPLN non-linear waveguide 302 is also connected to a single probe optical signal 318. The probe optical signal 318 may be provided by a laser outputting an optical signal at an optical frequency of f_{probe} and amplitude A″. The optical signals connected to the PPLN non-linear waveguide 302 combine together and produce a number of optical signals that are output from the PPLN non-linear waveguide 302. An optical filter 320 is used to filter out all of the signals except the optical signal having an amplitude that is proportional to the data B that is modulated. The desired output optical signal is at an optical frequency of fₒᵤₜ=2f_{qpm}−f_{probe}.

The converter 300 depicted in FIG. 3 generates a plurality of digitally modulated optical bit streams 304 or signals. Each of the digitally modulated optical streams 304 correspond to a respective one of the bit streams of the digital-electrical data being modulated. Accordingly, for an N-bit digital electrical signal comprising N digital-electrical bit streams, N digitally modulated optical bit streams are generated. The amplitude of the modulated optical signal corresponds to the bit-significance of the corresponding bit being modulated. That is, the digitally modulated optical signal that is modulated by the most significant bit of the digital-electrical data will have the largest amplitude and the digitally modulated optical signal that is modulated by the least significant bit of the digital-electrical data will have the smallest amplitude. As described above, the single modulated optical signal corresponding to the digital electrical data will be output at a shifted frequency of fₒᵤₜ and will have an amplitude that is proportional to the sum of the individual amplitudes of the modulated optical signals. The optical frequency of the output optical signal may be shifted according to a probe signal. If the potentially high frequency of 2f_{qpm} is acceptable, no probe signal is required and the optical frequency of the output signal would be fₒᵤₜ=2f_{qpm}. If a lower frequency output is required, or desired, the probe signal 318 may be coupled to the PPLN waveguide in order to shift the optical frequency of the output optical signal to fₒᵤₜ=2f_{qpm}−f_{probe}.

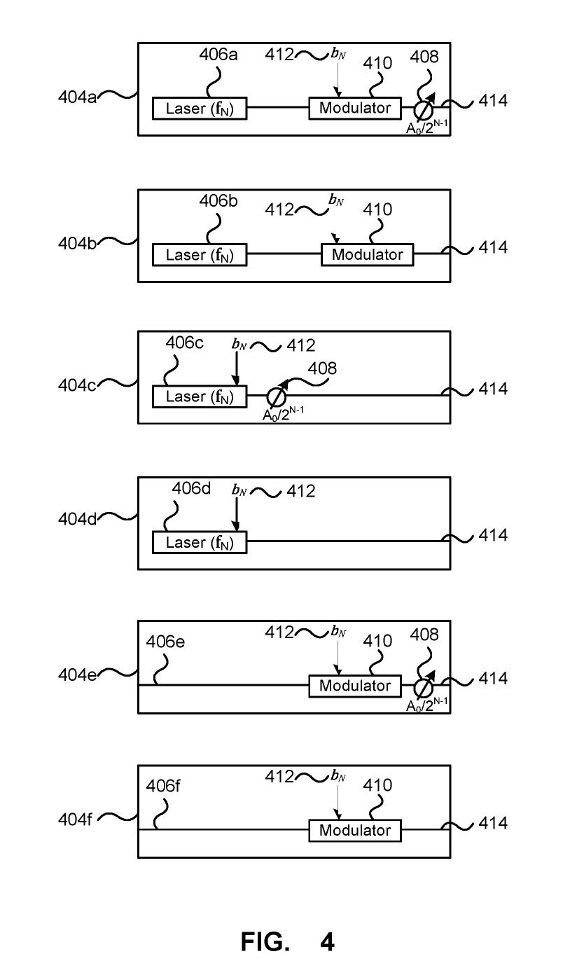

FIG. 4 depict digitally modulated bit stream source variants. FIG. 3 depicted a particular implementation of a digitally modulated bit stream source 304. One of ordinary skill in the art will appreciate that other implementations of the digitally modulated bit stream sources 304 are possible, some of which are depicted in FIG. 4. A digitally modulated bit stream source 404a is depicted as being provided by a laser 406a that outputs a continuous wave optical signal at an optical frequency of f_{N} and at an amplitude greater than

$$\frac{{A}_{0}}{{2}^{N - 1}} .$$

The laser 406a is optically coupled to a modulator 410 that modulates the continuous wave optical signal according to an associated bit, depicted as bit b_{N} 412, of the multi-bit electrical data. The modulated optical signal output from the modulator 410 has an amplitude greater than

$$\frac{{A}_{0}}{{2}^{N - 1}} .$$

An attenuator 408 attenuates the amplitude of the modulated digital signal to

$$\frac{{A}_{0}}{{2}^{N - 1}} .$$

The digitally modulated bit stream source 404a has an output 414 at which the digitally modulated optical signal is output from the digitally modulated bit stream source.

A digitally modulated bit stream source 404b is similar to the digitally modulated bit stream source 404a however, it does not include an attenuator. Rather, the laser 406b outputs the continuous wave optical signal at an amplitude of

$$\frac{{A}_{0}}{{2}^{N - 1}}$$

and as such no further attenuation is required. The optical signal from the laser 406b is modulated by modulator 410 according to bit b_{N} 412 and provided at an output 414.

A digitally modulated bit stream source 404c is similar to the digitally modulated bit stream sources 404a, 404b however, the laser 406c is directly modulated according to bit b_{N} 412. The modulated optical signal output from the laser 406c has an amplitude greater than

$$\frac{{A}_{0}}{{2}^{N - 1}} ,$$

and an attenuator 408 attenuates the amplitude to

$$\frac{{A}_{0}}{{2}^{N - 1}}$$

and provided at an output 414.

A digitally modulated bit stream source 404d is similar to the digitally modulated bit stream sources 404a, 404b, 404c however, the laser 406d is directly modulated according to bit b_{N} 412, and outputs an optical signal having an amplitude of

$$\frac{{A}_{0}}{{2}^{N - 1}} .$$

The output of the directly modulated laser is provided at an output 414 of the digitally modulated bit stream source 404d.

A digitally modulated bit stream source 404e is similar to the digitally modulated bit stream sources 404a, 404b, 404c, 404d however, it does not include the laser source. Rather, a continuous wave optical signal having an amplitude greater than

$$\frac{{A}_{0}}{{2}^{N - 1}}$$

can be coupled to an input 406e of the modulated bit stream source 404e. The optical signal is modulated by modulator 410 according to bit b_{N} 412 and an attenuator 408 attenuates the amplitude of the modulated optical signal. The attenuated modulated optical signal is provided at the output 414.

A digitally modulated bit stream source 404f is similar to the digitally modulated bit stream source 404e; however, it does not include an attenuator. A continuous wave optical signal that has an amplitude of

$$\frac{{A}_{0}}{{2}^{N - 1}}$$

is provided at an input 406f and the optical signal may be modulated according to bit b_{N} 412. The modulated optical signal is provided at an output 414 of the digitally modulated bit stream source 404f.

As described above, with particular reference to FIG. 4, numerous implementations for providing a digitally modulated bit stream source are possible. The plurality of digitally modulated bit stream sources described with reference to FIG. 3 may be provided according to any of the digitally modulated bit stream sources 404a-404f described with reference to FIG. 4. Further, it is possible for individual ones of the plurality digitally modulated bit stream sources to be provided by different implementations. Attenuators may be provided on CW complementary sources, or the CW complementary sources may be power adjustable.

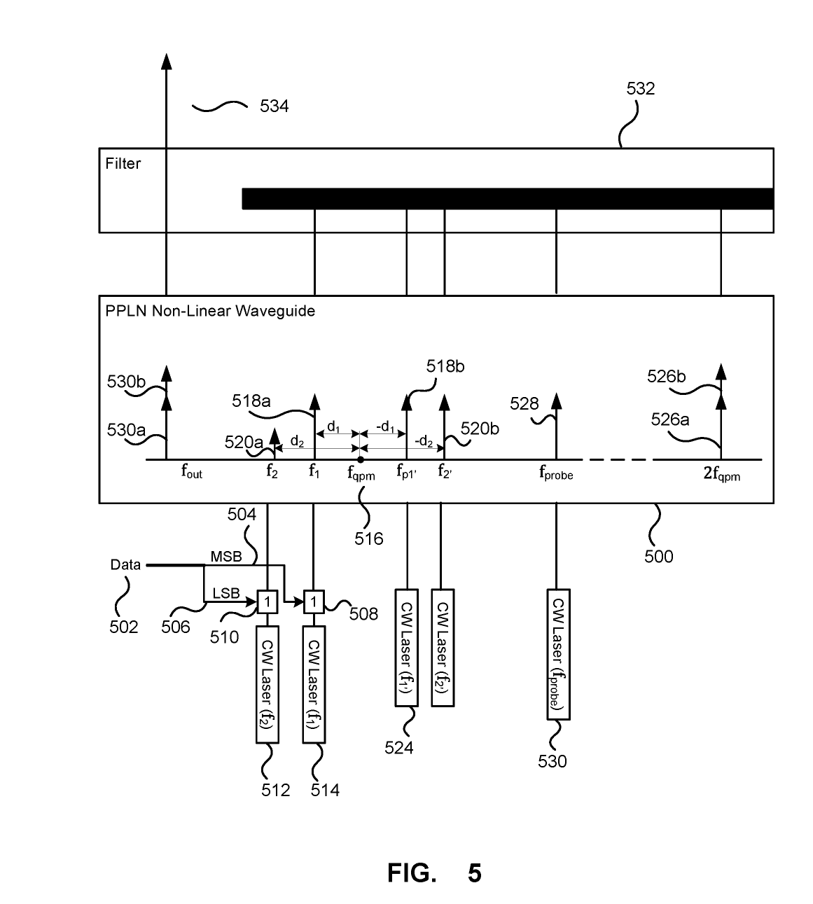

FIG. 5 depicts the conversion of a multi-bit digital-electrical signal to an analog optical signal using a PPLN waveguide 500. Digital-electrical data 502 being converted in FIG. 5 is depicted as being a 2-bit digital signal having a most significant bit 504 and a least significant bit 506. In particular, the data has a value of ‘3’ and so each bit is a ‘1’. Each digital-electrical bit 504, 506 is used to control a switch or modulator 508, 510 that each modulate respective optical signals provide by first 512 and second 514 lasers. Each laser 512, 514 provides a continuous wave optical signal at a particular frequency f₁, and f₂ respectively. Although not depicted in FIG. 5, the amplitudes of each of the optical signals are attenuated according to the significance of the bit used to modulate the optical signal. For example, the optical signal provide by the first laser 512, which is modulated by the most significant bit 504 will have a most significant amplitude, that is the amplitude of the optical signal will be the largest of the optical signals to be modulated. Similarly the optical signal provide by the second laser 514, which is modulated by the least significant bit 506 will have a least significant amplitude, that is the amplitude of the optical signal will be the smallest of the optical signals to be modulated. The modulated optical signals are coupled to a PPLN waveguide 500, which has a quasi-phase matched frequency of f_{qpm}, depicted as point 516. The modulated signals are represented schematically by arrows 518a, 520a. The height of the arrows 518a, 520a is intended to represent schematically the amplitude of the optical signal. Accordingly, the arrow 518a associated with the most significant bit is larger than arrow 520a associated with the least significant bit. Each of the modulated optical signals have respective optical frequencies that are spaced from f_{qpm}. For example, f₁ associated with the most significant bit is spaced a distance d₁ from f_{qpm} and f₂ associated with the least significant bit is spaced a distance d₂ from f_{qpm}, where d₂>d₁. It is noted that the specific optical frequencies and distances from f_{qpm} of the optical signals modulating particular bits may change. That is the most significant bit could be used to modulate an optical signal at an optical frequency of f₂ and the least significant bit could be used to modulate an optical signal at an optical frequency of f₁.

The multiple digitally modulated optical signals 518a, 520a are combined together into a single optical signal having an optical frequency of 2f_{qpm} within the PPLN non-linear waveguide according to the SFG process. In order to combine the modulated optical signals 518a, 520a together at an optical frequency of 2f_{qpm}, individual pump optical signals 518b, 520b are coupled to the PPLN non-linear waveguide 500. The optical frequencies f_{1′}, f_{2′} of pump optical signals 518b, 520b are complimentary of the corresponding modulated optical signals about f_{qpm}. That is, each of the individual pump signals 518b, 520b is associated with one of the modulated signals 518a, 520a and is located an equidistance away from, but on the opposite side of, f_{qpm}. Accordingly, pump signal 518b has an optical frequency of f_{1′}=2λ_{qpm}−f₁ and pump signal 520b has an optical frequency of f_{2′}=2f_{qpm}−f₂. The pump signals 518b, 520b may be provided by respective continuous wave lasers 522, 524 and may each have the same amplitude. The SFG process combines pairs of pump signals and modulated signals into a single optical signal at an optical frequency of 2f_{qpm}. As depicted, the combined generated optical signal comprises a component 526a corresponding to the most significant bit modulated signal and a second component 526b corresponding to the least significant bit modulated signal.

Although the SFG generated signal 526a, 526b provides an optical signal corresponding to the data to be converted, the optical frequency may be undesirably high, corresponding to an undesirably high frequency 2f_{qpm}. A difference frequency generation (DFG) process within the PPLN non-linear waveguide 500 may be used to generate another frequency-shifted optical signal at a lower frequency, and larger wavelength, corresponding to the SFG generated signal 526a, 526b. A probe optical signal 528 is provided to the PPLN non-linear waveguide 500 by a laser 530. The probe optical signal 528 has an optical frequency of f_{probe}. The particular wavelength of the probe may be selected in order to tune the wavelength of the output optical signal. In particular, the probe signal 528 and the SFG generated signal 526a, 528 combine to generate a DFG signal at fₒᵤₜ=2f_{qpm}−f_{probe}. As depicted, the amplitude of DFG generated signal 530a, 530b corresponds to the amplitude of the SFG generated signal 526a, 526b, but is shifted to a more desirable frequency of fₒᵤₜ.

All of the optical signals that are input into the PPLN non-linear waveguide 516 as well as the signals generated within the PPLN non-linear waveguide 516 are output from the PPLN non-linear waveguide 516. As depicted, an optical filter 532 is used in order to block all of the signals except the desired output signal 534 at an optical frequency of fₒᵤₜ. Accordingly, a single optical signal 534 having an optical frequency of fₒᵤₜ and an amplitude corresponding to the multi-bit data being converted is output from the optical filter 534.

As described above, a multi-bit digital-electrical data signal can be converted to an amplitude modulated optical signal by a PPLN non-linear waveguide and optical filter. By supplying the PPLN waveguide with N-digitally modulated optical signals and N pump optical signals at appropriate optical frequencies, an optical signal can be generated that is proportional to the sum of the amplitudes of the modulated signals. By supplying a probe optical signal at an appropriate frequency to the PPLN waveguide, the combined optical signal can be output at a lower frequency more suitable for operation with other system components.

FIG. 5 illustrates converting a 2-bit digital-electrical signal to a single analog-optical signal using a PPLN non-linear waveguide and optical filter. It will be appreciated that the same process may be used for converting multi-bit signals of greater than 2 bits. The process for converting an N-bit digital-electrical signal comprises digitally modulating N optical signals according to N bit streams of the N-bit digital-electrical signal. The N modulated optical signals are then combined with N pump optical signals and a probe optical signal in a PPLN non-linear waveguide. The PPLN non-linear waveguide combines the signals together by a cascade of a SFG process and a DFG process, which generates a frequency-shifted output optical signal at an output frequency that has an amplitude corresponding to the N-bit digital electrical signal. The output from the PPLN non-linear waveguide comprises a number of optical signals, which may be filtered out in order to provide the desired output optical signal.

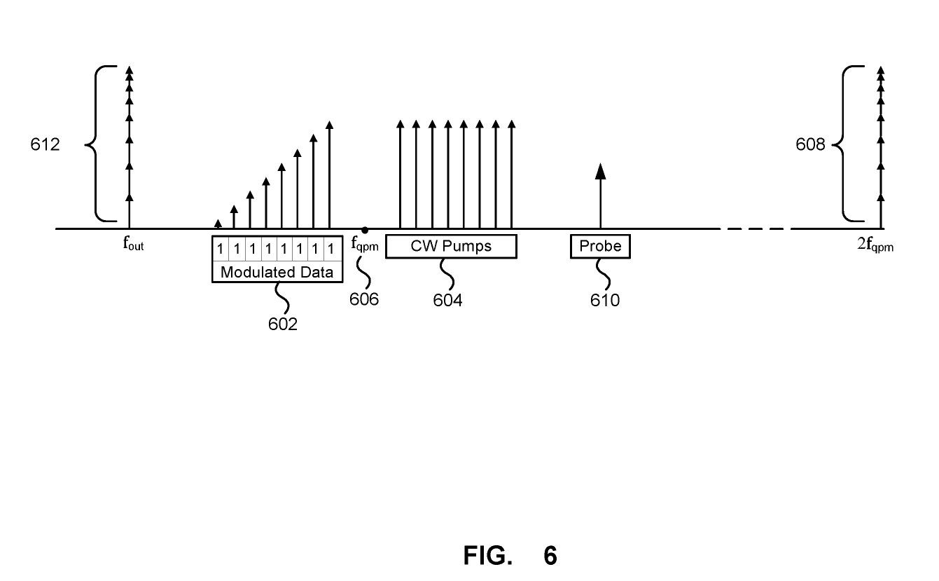

FIG. 6 depicts conversion of an 8 bit data signal to an amplitude modulated optical signal within a PPLN non-linear waveguide. The process depicted in FIG. 6 is substantially similar to that described above and uses the SFG process in order to generate a combined optical signal 608 that is a combination of modulated optical signals 602 that are modulated according to the individual bit streams of the data to be converted. Each of the individual modulated optical signals 602 combines with corresponding pump signals 604. Each of the pump signals 604 is at an optical frequency that is complementary to the optical frequency of the corresponding modulated optical signal 602 about a QPM frequency 606 of the PPLN waveguide. In order to provide an output optical signal at a desired frequency, a DFG process may combine the optical signal 608 with a probe optical signal 610 to generate an output optical signal 612, which has an amplitude proportional to the combined optical signal 608 and so also proportional to the sum of the amplitudes of the modulated optical signals. That is the amplitude of the output signal 612 is described by:

Aₒᵤₜ∝Σ_{i=1 . . . N}(Aᵢ*A_{i′})*A_{probe} (6)

If A_{i′} is the same for all i, equation (6) may be reduced to:

Aₒᵤₜ∝Σ_{i=1 . . . N}Aᵢ (7)

From the above, if

$${A}_{i} ∝ \frac{{b}_{i}}{{2}^{i - 1}}$$

then

$${A}_{out} ∝ {\sum }_{i = 1 … N} \frac{{b}_{i}}{{2}^{i - 1}}$$

and as such Aₒᵤₜ∝B, where B is the multi-bit digital-electrical data signal. Accordingly, by appropriately selecting, or attenuating, the amplitudes of the modulated optical signals it is possible to generate a single optical signal that has an amplitude that is proportional to the data being modulated.

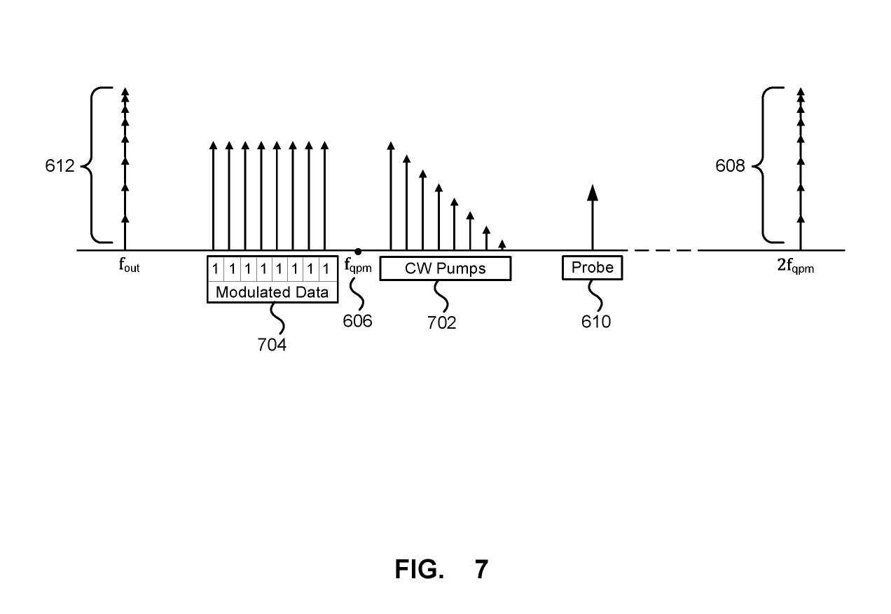

FIG. 7 depicts a further conversion of an 8 bit data signal to an amplitude modulated optical signal within a PPLN non-linear waveguide. The above has described attenuating the amplitude of the optical signals being modulated according to the bit streams of the data. However, as depicted in FIG. 7, rather than attenuating the amplitude of the modulated optical signals 704, it is possible to attenuate the amplitude of the pump optical signals 702. The combination of the attenuated pump signals 702 and modulated data signals 704 results in the same optical signal 608 and output optical signal 612 being generated.

Although described above as attenuating the amplitudes of either the pump optical signals or the modulated optical signal, it will be appreciated that the amplitudes of both the CW pumps and the modulated optical signals may be attenuated.

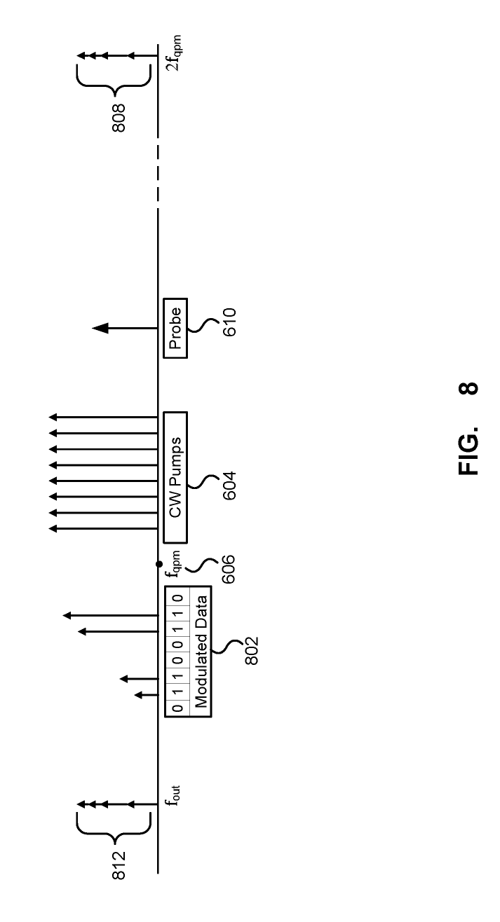

FIGS. 5-7 have depicted the modulation of data signals where each bit has a value of ‘1’. FIG. 8 depicts the digital-electrical to analog-optical conversion process when one or more of the bit streams 802 have a value of ‘0’. As depicted in FIG. 8, when the optical signals are modulated by a data bit of ‘0’, the modulator effectively blocks the optical signal, or attenuates its amplitude to substantially ‘0’. Accordingly, without a modulated optical signal present, a combination signal 808 does not include a corresponding component from the modulated optical signal. In other words, the amplitude component added to the combined signal 808 from the optical signal modulated by the ‘0’ data bit corresponds to the amplitude of the modulated signal, which is 0. Similarly to FIG. 6, an output signal 812 of FIG. 8 corresponds in amplitude to the combined signal 808. Accordingly, the combined signal includes only those amplitude components associated with the modulated optical signals modulated by a data bit value of ‘1’.

The particular wavelengths used for modulating the data and the corresponding pump signals may vary depending upon various design considerations. However, one illustrative frequency assignment for an 8-bit signal is depicted in Table 1 below. In Table 1 pump1-8 are the CW pump signals, QPM is the quasi-phase matching point and signal1-8 are the modulated optical signals. It is noted that the wavelength/frequency of the probe may be varied, and as such the output wavelength/frequency varied, as long as it does not coincide with other pump or signal wavelengths/frequencies.

TABLE 1
Illustrative wavelength and frequency assignments

| Signal | Wavelength (nm) | Frequency (THz) |
|---|---|---|
| 2QPM | 775.06 | 386.80 |
| probe | 1462.02 | 205.00 |
| pump8 | 1537.40 | 195.00 |
| pump7 | 1538.98 | 194.80 |
| pump6 | 1540.56 | 194.60 |
| pump5 | 1542.15 | 194.40 |
| pump4 | 1543.73 | 194.20 |
| pump3 | 1545.33 | 194.00 |
| pump2 | 1546.92 | 193.80 |
| pump1 | 1548.52 | 193.60 |
| QPM | 1550.12 | 193.40 |
| signal1 | 1551.72 | 193.20 |
| signal2 | 1553.33 | 193.00 |
| signal3 | 1554.94 | 192.80 |
| signal4 | 1556.56 | 192.60 |
| signal5 | 1558.18 | 192.40 |
| signal6 | 1559.80 | 192.20 |
| signal7 | 1561.42 | 192.00 |
| signal8 | 1563.05 | 191.80 |
| output | 1649.02 | 181.80 |

The above has described the use of a PPLN non-linear waveguide and optical filter as a digital to analog optical converter. The digital to analog conversion is based on cascaded non-linear frequency mixing of optical signals in a micro-structured PPLN waveguide. The PPLN non-linear waveguide is a passive optical device and as such no additional noise is added by the waveguide. Further, the PPLN non-linear waveguide may have a relatively wide bandwidth. The digital to optical conversion process allows separation of the RF digital-electrical to digital-optical modulation and the digital-optical to analog-optical conversion processes. The separation allows the RF electrical signals to be physically separated from each other by a sufficient distance to reduce or eliminate RF crosstalk between the electrical signals. Although the digital to analog optical conversion process described above may be applied to a number of different applications, it may be well suited for use in radio over fiber (RoF) applications.

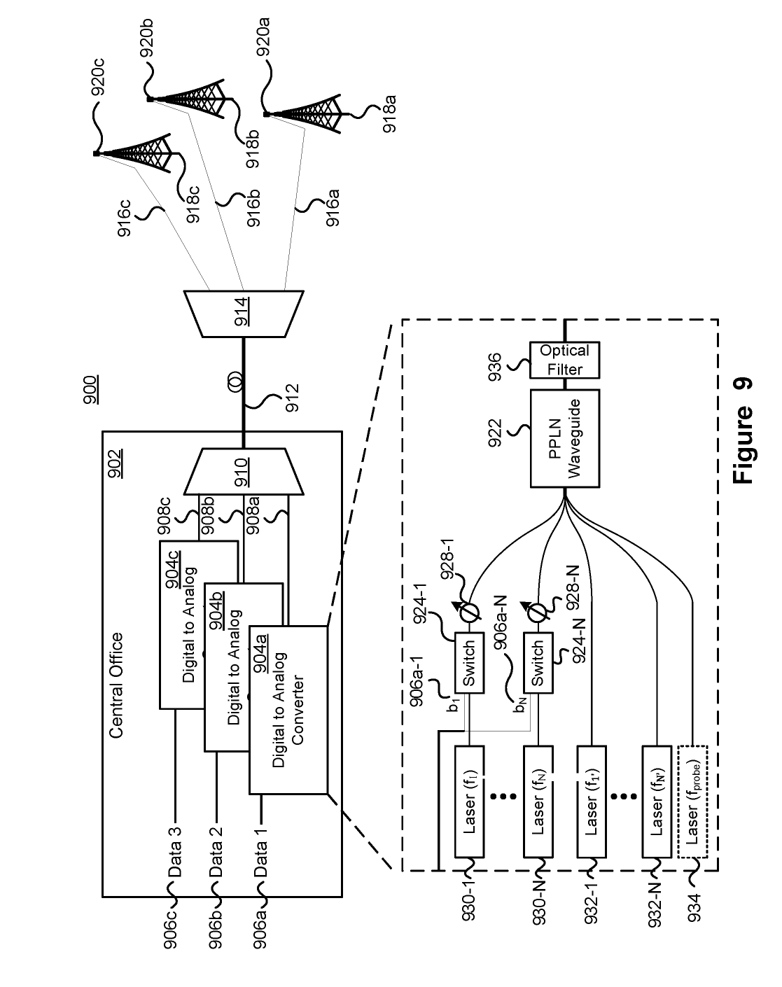

FIG. 9 depicts a radio over fiber (RoF) transmission system 900 incorporating a digital-electrical to analog-optical converter. The RoF system 900 comprises a central office 902 at which digital data is converted into an analog optical signal that can be transmitted over optical cables to remote locations. Although referred to as a central office, the digital-electrical to analog-optical converter may be located at any location where digital-electrical to analog-optical conversion is performed. As depicted, a central office 902 may comprise a plurality of digital-electrical to analog-optical converters 904a-904c (referred to collectively as digital to analog converters 904) that each convert a multi-bit digital electrical signal 906a-906c (referred to collectively as digital-electrical signals 906) to a corresponding analog-optical signal 908a-908c (referred to collectively as analog-optical signals 908). Each of the analog-optical signals 908 may be an amplitude modulated signal at a particular wavelength. If each of the analog-optical signals 908 are at different wavelengths, the plurality of analog-optical signals 908 can be multiplexed into a single output signal by a wavelength multiplexer 910. The output signal, which may comprise a plurality of analog-optical signals multiplexed together, can be transmitted over a fiber optic cable 912. The fiber optic cable 912 may be connected between the multiplexer 910 and a demultiplexer 914. The fiber optic cable 912 may carry the output signal a relatively large distance such as up to 20 km, although greater lengths are possible. The demultiplexer 914 demultiplexes each of the optical signals 908 output from the digital to analog modulators 904. The demultiplexer 914 may be coupled to a plurality of transmitters 920a-920c (referred to collectively as transmitters 920) by a relatively short length of fiber optic cables 916a-916c (referred to collectively as fiber optic cables 916). The length of the fiber optic cables 916 coupling the demultiplexer 914 to the transmitters 920 may be for example up to 900 m, although greater lengths are possible or more. As depicted, each of the transmitters 920 may be located at respective cell sites 918a-918c (referred to collectively as cell sites 918). The cell sites may be located at separate physical locations as depicted in FIG. 9, or may be separate cell sectors located at the same physical location. Each of the transmitters may include an optical detector for converting the analog optical signal to an analog electrical signal for use in driving the transmitter antenna.

Each of the digital to analog converters 904 generates an amplitude modulated analog-optical signal 908 that corresponds to the digital-electrical data signals 906 that are each a multi-bit digital signal. For example, each of the digital-electrical data signals 906 may comprise 8 or 10 individual bit streams of digital-electrical signals. Each of the digital to analog converters 904 converts electrical data into a corresponding optical signal. Each of the converters 904 may comprise a plurality, N, of lasers 930-1-930-N that each provide a continuous wave optical signal at a particular frequency fᵢ for i=1 . . . N. Each of the optical signals is modulated by a modulator, which may be an optical switch 924-1-924-N, that is controlled by a respective bit stream of the data 906-1-906-N. Each of the modulated optical signals may be attenuated by respective attenuators 928-1-928-N so that the amplitude of the optical signal corresponds to the bit significance of the bit stream being modulated. The attenuated modulated optical signals are coupled to a PPLN waveguide 922. In addition to the N modulated optical signals, N corresponding pump signals, provided by respective lasers 932-1-932-N are also coupled to the PPLN waveguide 922. As described above, the optical frequencies of the pump lasers are set according to 2f_{qpm}=fᵢ+f_{i′} for i=1 . . . N. Further, a probe optical signal, provide by a probe laser 934 with an optical frequency of f_{probe} may be connected to the PPLN waveguide 922 if it is desirable to output an optical signal at a lower frequency. The optical signals mix within the PPLN waveguide and generate an output signal at a wavelength of λₒᵤₜ, which is filtered out from other optical signals present in the output of the PPLN by an optical filter 936. The output of the optical filter 936 is an amplitude modulated optical signal whose amplitude corresponds to the N-bit data signal.

The above has described various functionality provided by various systems or components. Although specific embodiments are described herein, it will be appreciated that modifications may be made to the embodiments without departing from the scope of the current teachings. Accordingly, the scope of the appended claims should not be limited by the specific embodiments set forth, but should be given the broadest interpretation consistent with the teachings of the description as a whole.

What is claimed is:

1. A digital to analog converter (DAC) for converting an N-bit digital electrical signal into a corresponding analog optical signal, the DAC comprising:
N digitally modulated optical bit stream sources, wherein each modulated optical bit stream source is configured for providing an optical signal at a distinct optical frequency fₙ, wherein the optical signal at the distinct optical frequency fₙ is modulated according to a respective bit bₙ of the N-bit digital-electrical signal;
a non-linear optical element optically coupled to the N digitally modulated optical bit stream sources and configured for outputting a frequency-shifted optical signal when coupled to N complementary optical signals each of the N complementary optical signals having an optical frequency of fₙ*, wherein fₙ+fₙ*=2f_{qpm} for n=1 . . . N, where f_{qpm} is a quasi-phase matching (QPM) frequency of the non-linear optical element, and wherein the frequency-shifted optical signal has an optical frequency of 2f_{qpm}; and
an optical filter optically coupled to an output of the non-linear optical element and configured for outputting the analog optical signal at an optical frequency f_{filter} while suppressing the optical signals at the optical frequencies fₙ and fₙ*, wherein the analog optical signal is based on the frequency-shifted optical signal.

2. The DAC of claim 1, wherein the non-linear optical element comprises a periodically poled non-linear waveguide configured for generating the frequency-shifted optical signal based on a sum frequency generation (SFG) process within the periodically poled non-linear waveguide.

3. The DAC of claim 2, further comprising a probe signal source optically coupled to the periodically poled non-linear waveguide for providing a probe optical signal having an optical frequency of f_{probe}, wherein f_{filter}=2f_{qpm}−f_{probe}; wherein the periodically poled non-linear waveguide is configured for generation of a second frequency-shifter optical signal based on difference frequency generation (DFG) process between the frequency-shifted optical signal and the probe optical signal in the periodically poled non-linear waveguide.

4. The DAC of claim 1, wherein b₁ is a most significant bit and b_{N} is a least significant bit of the N-bit electrical-digital signal, and wherein each of the N digitally modulated optical bit stream sources is associated with modulating a respective optical signal having an amplitude of
$${A}_{n} = \frac{{A}_{0}}{{2}^{n - 1}} ,$$
where A₀ is an amplitude representing the most significant bit.

5. The DAC of claim 4, wherein one or more of the N digitally modulated optical bit stream sources comprise:
a laser outputting an optical signal at the respective frequency fₙ at an amplitude greater than Aₙ;
an attenuator for attenuating the amplitude of the optical signal to Aₙ; and
a modulator for modulating the optical signal according to the respective bit bₙ of the digital electrical signal.

6. The DAC of claim 5, wherein the attenuator is coupled between the laser and the modulator.

7. The DAC of claim 4, wherein one or more of the N digitally modulated optical bit stream sources comprise:
a laser outputting an optical signal at the respective frequency fₙ at an amplitude of Aₙ; and
a modulator for modulating the optical signal according to the respective bit bₙ of the digital electrical signal.

8. The DAC of claim 4, wherein the periodically poled non-linear waveguide comprises a periodically poled lithium niobate (PPLN) waveguide.

9. The DAC of claim 4, wherein one or more of the N digitally modulated optical bit stream sources comprise:
a directly modulated laser diode outputting an optical signal at the respective frequency fₙ at an amplitude of Aₙ that is modulated according to the respective bit bₙ of the digital electrical signal.

10. The DAC of claim 1, further comprising N continuous wave laser diodes optically coupled to the non-linear optical element for providing the N complementary optical signals.

11. The DAC of claim 1, further comprising one or more multi-wavelength optical sources optically coupled to the non-linear optical element for providing the N complementary optical signals.

12. A radio over fiber (RoF) system for transmitting a plurality of analog radio-frequency signals to a plurality of transmission locations, the RoF system comprising:
a plurality of digital to analog converters (DACs), each of the plurality of DACs for converting an N-bit digital electrical signal into a corresponding analog optical signal and comprising:
N digitally modulated optical bit stream sources, wherein each modulated optical bit stream source is configured for providing an optical signal at a distinct optical frequency fₙ, wherein the optical signal at the distinct optical frequency fₙ is modulated according to a respective bit bₙ of the N-bit digital-electrical signal;
a non-linear optical element optically coupled to the N digitally modulated optical bit stream sources and configured for outputting a frequency-shifted optical signal when coupled to N complementary optical signals each of the N complementary optical signals having an optical frequency of fₙ*, wherein fₙ+fₙ*=2f_{qpm} for n=1 . . . N, where f_{qpm} is a quasi-phase matching (QPM) frequency of the non-linear optical element, and wherein the frequency-shifted optical signal has an optical frequency of 2f_{qpm}; and
an optical filter optically coupled to an output of the non-linear optical element and configured for outputting the analog optical signal at an optical frequency f_{filter} while suppressing the optical signals at the optical frequencies fₙ and fₙ*, wherein the analog optical signal is based on the frequency-shifted optical signal;
a wavelength multiplexer for multiplexing the plurality of analog optical signals output from the optical filters of the plurality of DACs into a single optical fiber output;
a wavelength demultiplexer for demultiplexing the plurality of optical signals; and
an optical fiber coupling the wavelength multiplexer to the wavelength demultiplexer.

13. The RoF system of claim 12, further comprising:
a plurality of transmitters each located at a respective one of the plurality of transmission locations and coupled to a respective one of the plurality of optical signals output from the wavelength demultiplexer, each of the transmitters comprising:
a photo detector for converting the respective optical signal to a corresponding radio frequency (RF) electrical signal;
an electrical amplifier for amplifying the RF electrical signal to an RF driving signal; and
an antenna for radiating the RF driving signal in free space.

14. The RoF system of claim 13, wherein each of a plurality of optical fibers coupling the optical signals output from the wavelength demultiplexer to the respective transmitters have a respective length of less than 800 m.

15. The RoF system of claim 12, wherein the optical fiber coupling the wavelength multiplexer to the wavelength demultiplexer is between 0 km and 20 km in length.

16. The RoF system of claim 12, wherein the non-linear optical element of one or more of the plurality of DACs comprises a periodically poled lithium niobate (PPLN) waveguide.

17. A method of converting an N-bit digital-electrical signal to a corresponding analog-optical signal, the method comprising:
digitally modulating N optical signals according to N bit streams of the N-bit digital-electrical signal;
combining the N digitally modulated signals with N pump optical signals in a non-linear optical element; and
filtering an output of the non-linear optical element to provide an output analog optical signal having an amplitude corresponding to the N-bit digital-electrical signal.

18. The method of claim 17, wherein the N digitally modulated optical signals each have a respective frequency of fₙ, where n corresponds to a significance of the bit, bₙ, modulating the optical signal, with bit b₁ being a most significant bit and b_{N} being a least significant bit of the N-bit electrical-digital signal and the N pump signals each have an associated frequency of fₙ*, where 2f_{qpm}=fₙ+fₙ* for n=1 . . . N and f_{qpm} is a quasi-phase matching (QPM) frequency of the non-linear optical element.

19. The method of claim 18, wherein the non-linear optical element comprises a periodically poled non-linear waveguide, the method further comprising combining a probe signal having an optical frequency of f_{probe} with the N digitally modulated signals and the N pump optical signals in the periodically poled non-linear waveguide, wherein the output of the periodically poled non-linear waveguide is filtered to output an optical signal at a wavelength of f_{filter}=2f_{qpm}−f_{probe}

20. The method of claim 18, further comprising:
attenuating each of the N optical signal to an amplitude of
$${A}_{n} = \frac{{A}_{0}}{{2}^{n - 1}} ,$$
where A₀ is an amplitude representing the most significant bit.
